(19) United States
(12) Patent Application Publication
(10) Pub. No.: US 2020/0191588 A1
(43) Pub. Date: Jun. 18, 2020

(54) SYSTEM AND METHOD FOR PROVIDING OPTIMAL-FUEL-EFFICIENCY DRIVING PATTERN ACCORDING TO TRAVEL ROUTE

(71) Applicants: HYUNDAI MOTOR COMPANY, Seoul (KR); KIA MOTORS CORPORATION, Seoul (KR)

(72) Inventor: Sang Soon PARK, Seoul (KR)

(73) Assignees: HYUNDAI MOTOR COMPANY, Seoul (KR); KIA MOTORS CORPORATION, Seoul (KR)

(21) Appl. No.: 16/592,968

(22) Filed: Oct. 4, 2019

(30) Foreign Application Priority Data
Dec. 14, 2018 (KR) 10-2018-0161990

(51) Int. Cl. G01C 21/34; G07C 5/08; G01C 21/36; H04W 4/44; H04W 4/38; G08G 1/0968

(52) U.S. Cl. CPC G01C 21/3469; G07C 5/085; G01C 21/3626; G08G 1/096811; H04W 4/38; G08G 1/096855; H04W 4/44

(57) ABSTRACT

A system and method for providing an optimal-fuel-efficiency driving pattern for a vehicle according to a travel route, which are capable of providing guide information to a driver in real time such that a vehicle travels according to an optimal driving pattern matching road conditions of the travel route, weather and vehicle information when the driver drives the vehicle in a state of setting the travel route to a specific destination. The vehicle infotainment system collects traveling information of a pre-registered vehicle and customer data at a predetermined period, analyzes, stores and manages a driving pattern of the vehicle and fuel efficiency information with respect to the travel route, transmits the optimal-fuel-efficiency driving pattern data to the vehicle infotainment system when a pre-registered user requests the optimal-fuel-efficiency driving pattern data for the specific route.

### CROSS-REFERENCE TO RELATED APPLICATION

This application claims priority to and the benefit of Korean Patent Application No. 10-2018-0161990, filed on Dec. 14, 2018, the entire contents of which are incorporated herein by reference.

### FIELD

The present disclosure relates to a system for providing an optimal-fuel-efficiency driving pattern according to a travel route and, and a method for providing a driver with an optimal-fuel-efficiency driving pattern matching road conditions of a travel route of a vehicle.

### BACKGROUND

The statements in this section merely provide background information related to the present disclosure and may not constitute prior art.

Fuel efficiency of a vehicle depends on various road environments such as urban roads, sloping mountain roads or highways and various conditions such as driver tendencies.

Recently developed vehicles provide a driver with functions to select a travel mode by only simple operation according to driver tendency, travel environments and a driver mood.

For example, modes for providing optimal travel environments according to engine throttle (valve) reaction, a time desired for gear shift of a transmission, steering wheel reaction, suspension damping, etc. are generally divided into a normal mode, an eco mode and a sports mode (power mode).

Here, the eco mode improves or maximizes fuel efficiency on urban roads or highways. In the eco mode, engine throttle reaction is slowed and the gear is shifted based on a low speed. Even if a driver deeply presses an accelerator to increase revolutions per minute (RPM), since acceleration force is not transmitted without change, sudden acceleration may be restricted.

Korean Patent Registration No. 10-1448765 (Oct. 1, 2014) discloses an active eco driving control method and system capable of reducing fuel consumption at the time of active eco driving and improving a driving property by adjusting an acceleration/deceleration pattern according to driver intention.

Korean Patent Registration No. 10-1630044 (Jun. 7, 2016) discloses a smart care and eco integration system and method capable of providing a smart care and eco management function for preventing or efficiently coping with dangerous situations or accidents which may occur while a vehicle travels, by intelligently recognizing driver behavior, traveling situations, vehicle diagnosis information related to vehicle engine and components and bio information of a driver, and a monitoring function for reducing fuel consumption and pollutant emission.

However, fuel efficiency of the vehicle may vary depending on various driving variables such as road conditions, weather and the electronic apparatus of the vehicle. In the eco mode of the above-described conventional technologies, since such various variables are not applied in real time and the vehicle is controlled by only values set by the manufacturer when the vehicle is released, there is a limitation in achieving optimal fuel efficiency.

In addition, even when the driver drives the vehicle in a state of setting the eco mode, there is a limitation in achieving optimal fuel efficiency according to the driver's instantaneous operation and driving habits.

### SUMMARY

The present disclosure provides a system and method for providing an optimal-fuel-efficiency driving pattern according to a travel route that substantially obviate one or more problems due to limitations and disadvantages of the related art.

The system and method are capable of providing guide information to a driver in real time such that a vehicle travels with an optimal driving pattern which matches with road conditions of a travel route, weather and vehicle information when the driver drives the vehicle in a state of setting the travel route to a specific destination.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

In one form of the present disclosure, as embodied and broadly described herein, a system for providing an optimal-fuel-efficiency driving pattern according to a travel route includes: a vehicle infotainment system 100 installed in a pre-registered vehicle and configured to detect and transmit traveling information of the pre-registered vehicle to an external server and to guide a driver to drive the pre-registered vehicle using optimal-fuel-efficiency driving pattern data for a specific travel route downloaded from the external server; a service provider server 300 configured to collect traveling information of the pre-registered vehicle and customer data at a predetermined period, to analyze, store and manage a driving pattern of the pre-registered vehicle and fuel efficiency information with respect to the specific travel route, to transmit the optimal-fuel-efficiency driving pattern data to the vehicle infotainment system 100 when a pre-registered user requests the optimal-fuel-efficiency driving pattern data for the specific travel route; and a wireless communication network 200 configured to enable data communication between the vehicle infotainment system 100 and the service provider server 300.

In another aspect of the present disclosure, a method of providing an optimal-fuel-efficiency driving pattern for a vehicle according to a travel route includes: retrieving a travel route to a destination; requesting, by a service provider server, an optimal-fuel-efficiency driving pattern guide service for the travel route; extracting, by the service provider server, the travel route; determining, by the service provider server, whether optimal-fuel-efficiency driving pattern data matching the travel route is present among prestored driving pattern data; transmitting the travel route data and the optimal-fuel-efficiency driving pattern data from the service provider server to the vehicle when the optimal-fuel-efficiency driving pattern data matching the travel route is present; and providing the travel route and the optimal-fuel-efficiency driving pattern data.

It is to be understood that both the foregoing general description and the following detailed description of the present disclosure are exemplary and explanatory and are intended to provide further explanation of the present disclosure as claimed.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram showing the configuration of a system for providing an optimal-fuel-efficiency driving pattern according to a travel route;

FIG. 2 is a view illustrating a screen of a display when a vehicle travels according to an optimal-fuel-efficiency driving pattern according to the travel route; and

FIGS. 3 and 4 are flowcharts respectively illustrating a procedure of providing an optimal-fuel-efficiency driving pattern according to the travel route.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, the forms of the present disclosure will be described in detail with reference to the accompanying drawings so as to be easily implemented by those skilled in the art. However, the present disclosure may be variously implemented and is not limited to the forms described herein. In the drawings, in order to clearly describe the present disclosure, portions which are not related to the description of the present disclosure will be omitted and similar portions are denoted by similar reference numerals throughout the specification.

In the entire specification, when a certain portion “includes” a certain component, this indicates that other components are not excluded, but may be further included unless specially described. The terms “unit”, “-or/er,” “analyzer” and “module” described in the specification indicate a unit for processing at least one function or operation, which may be implemented by hardware (e.g., a processor), software or a combination thereof.

In the entire specification, when a certain portion “includes” a certain component, this indicates that the other components are not excluded, but may be further included unless specially described.

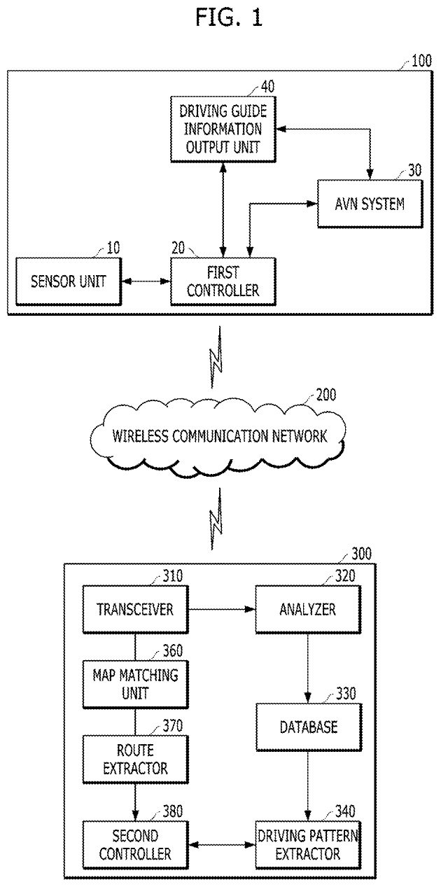

Hereinafter, the configuration and operation of a system for providing an optimal-fuel-efficiency driving pattern according to a travel route in exemplary forms of the present disclosure will be described in detail with reference to FIGS. 1 to 4.

FIG. 1 is a block diagram showing the configuration of a system for providing an optimal-fuel-efficiency driving pattern according to a travel route in one form of the present disclosure.

Referring to FIG. 1, the system for providing the optimal-fuel-efficiency driving pattern according to the travel route includes: a vehicle infotainment system 100 installed in a pre-registered vehicle to detect and transmit traveling information of the vehicle to an external server (e.g., a service provider server 300) and to guide a user to drive the vehicle using optimal-fuel-efficiency driving pattern data for a specific travel route downloaded from the external server (e.g., the service provider server 300), the service provider server 300 for collecting traveling information of the pre-registered vehicle and customer data at a predetermined period, analyzing, storing and managing the driving pattern of the vehicle and fuel efficiency information with respect to the travel route and transmitting the optimal-fuel-efficiency driving pattern data to the vehicle infotainment system 100 when a pre-registered user requests the optimal-fuel-efficiency driving pattern with respect to a specific route, and a wireless communication network 200 for enabling wireless data communication between the vehicle infotainment system 100 and the service provider server 300.

The traveling information may include at least one of a vehicle type, a vehicle speed, a Global Positioning System (GPS), an acceleration, a deceleration, a road type, a travel route, or time and weather information detected by various sensors including a camera.

Here, as shown in FIG. 1, the vehicle infotainment system 100 includes a sensor unit 10 including at least one sensor to detect predetermined vehicle traveling information, a first controller 20 for performing control to transmit the vehicle traveling information detected by the sensor unit 10 to the outside (e.g., an AVN system 30) or to output specific optimal-fuel-efficiency driving pattern data provided from the outside (e.g., the service provider server 300) under control of the user, and the AVN system 30 for performing wireless data communication with the external server (e.g., the service provider server 300), transmitting the traveling information received from the first controller 20 to the external server (e.g., the service provider server 300), and guiding the user to drive the vehicle using the optimal-fuel-efficiency driving pattern data for the specific travel route, which has been transmitted by the service provider server 300.

Here, the AVN system 30 is an abbreviation for an audio video navigation system, includes a communication device enabling wireless data communication with the service provider server 300, is capable of transmitting a variety of data generated by the first controller 20 and customer driving data to the service provider server 300, and is capable of downloading travel route data and the optimal-fuel-efficiency driving pattern data, which are transmitted by the service provider server 300, when the user requests an optimal-fuel-efficiency driving pattern guide service from the service provider server 300.

In addition, the AVN system 30 may transmit, to a control unit or a sensor, the data of the sensor unit 10 and the first controller 20 according to the specific travel route in a state of temporarily storing the data of the first controller 20 and the specific sensor unit 10 matching the travel route information downloaded from the service provider server 300, thereby integrally performing control.

Meanwhile, as shown in FIG. 1, the service provider server 300 includes a transceiver 310 for transmitting and receiving data to and from one or more vehicle infotainment systems 100, an analyzer 320 for collecting the traveling information received from each of the vehicle infotainment systems 100 and analyzing the fuel efficiency on the travel route and the driving pattern, a route extractor 370 for extracting the travel route to a specific destination through a map matching unit 360, in which map information and traveling roads are stored, according to the request of the transceiver 310, which has received the signal for requesting the optimal-fuel-efficiency driving pattern guide service for the specific destination from the pre-registered user, a driving pattern extractor 340 for extracting optimal driving pattern data achieving optimal fuel efficiency from the driving pattern data stored according to the travel route or storing the extracted optimal driving pattern data in a database 330 along with the travel route information, and a second controller 380 for retrieving optimal-fuel-efficiency driving pattern data matching a specific travel route and/or a vehicle type and a fuel type from among a plurality of driving pattern data extracted by the driving pattern extractor 340 and stored in the database 330 and transmitting the retrieved optimal-fuel-efficiency driving pattern data to the vehicle infotainment system 100.

In addition, the vehicle infotainment system 100 further includes a driving guide information output unit 40 installed to enable data communication between the first controller 20 and the AVN system 30 to output optimal-fuel-efficiency driving guide information including an acceleration amount, a steering angle and brake time point notification information of the driver while performing guidance on optimal-fuel-efficiency driving pattern data on the current travel route. The driving guide information output unit 40 uses a voice system or an augmented reality head-up display (AR-HUD) in order to further upgrade the functionality of the AVN system 30.

In addition, upon performing guidance on the optimal-fuel-efficiency driving pattern data on the current travel route, the first controller 20 may perform guidance on the optimal-fuel-efficiency driving pattern data through interworking with the AVN system 30 and the driving guide information output unit 40.

Meanwhile, as the first controller 20, a control unit (electronic control unit (ECU)), which electronically controls a powertrain system such as an engine, a transmission, etc., e.g., a transmission control unit (TCU) or an engine management system (EMS) is used. In a normal driving situation, a basic value of an eco mode set when the vehicle is released is used.

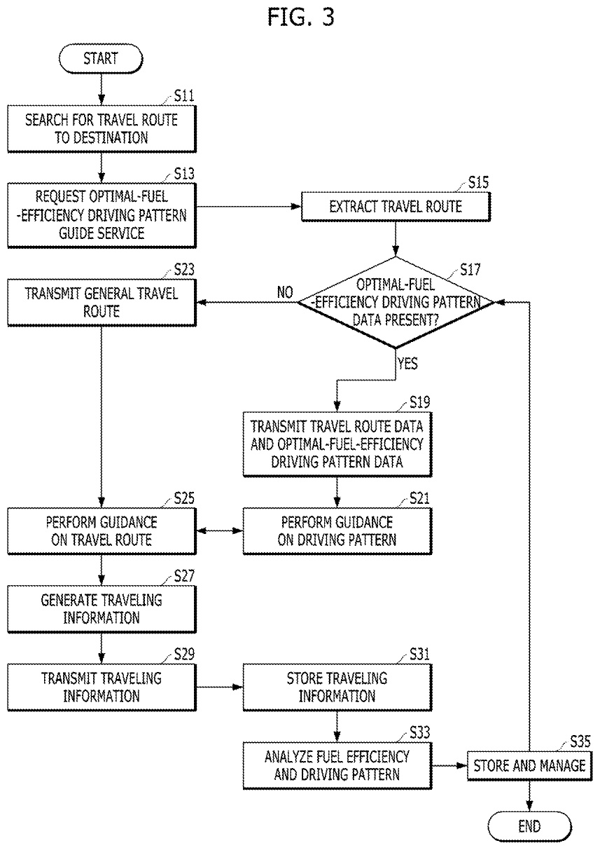

FIG. 3 is a flowchart illustrating a procedure of providing an optimal-fuel-efficiency driving pattern in one form of the present disclosure.

Referring to FIG. 3, a driver of a specific vehicle pre-registered with the service provider server 300 operates the AVN system 30 of the vehicle to retrieve a travel route to a specific destination (S11) and requests an optimal-fuel-efficiency driving pattern guide service for the selected specific travel route (S13).

The route extractor 370 of the service provider server 300 extracts the travel route by referring to the map matching unit 360 according to the request of the driver (S15).

Meanwhile, the analyzer 320 determines whether optimal-fuel-efficiency driving pattern data matching the travel route is present in the plurality of driving pattern data stored in the database 330 (S17).

At this time, when optimal-fuel-efficiency driving pattern data matching the travel route is present as the result of determination of S17, the second controller 380 of the service provider server 300 transmits the travel route data and the optimal-fuel-efficiency driving pattern data to the first controller 20 of the vehicle infotainment system 100 (S19), and the first controller 20, which has downloaded the travel route data and the optimal-fuel-efficiency driving pattern data, performs guidance on the travel route (S25), while performing guidance on optimal-fuel-efficiency driving pattern on the travel route (S21).

At this time, the first controller 20 may perform operation control according to the downloaded optimal-fuel-efficiency driving pattern in a state in which the driver turns on a switch for performing guidance on the optimal-fuel-efficiency driving pattern. However, in a state in which the driver turns off the switch for performing guidance on the optimal-fuel-efficiency driving pattern, guidance on the optimal-fuel-efficiency driving pattern may be subsidiarily performed and only fine adjustment is performed during driving control of the driver.

In addition, the driving pattern is of a ghost car type and a travel guide line (steering angle), an accelerator pedal effort, a braking time point and a braking pedal effort are displayed on an AR navigation system or an AR-HUD, under control of the first controller 20.

In addition, the controller 20 may perform control to automatically process portions in which the customer is not involved, such as a gear shift time point, in the vehicle and to output a message to the customer before driving when a portion different from the downloaded optimal-fuel-efficiency driving pattern among factors influencing fuel efficiency, such as tire pressure/operation of an electronic product, occurs.

In contrast, when optimal-fuel-efficiency driving pattern data matching the travel route is not present as the result of determination of S17, the second controller 380 of the service provider server 300 transmits a normal travel route stored in the database 330 (S23), and performs guidance on the travel route through the AVN system 30 under control of the first controller 20 of the vehicle infotainment system 100 (S25).

Thereafter, the first controller 20 detects predetermined vehicle driving data through the sensor unit 10 of the vehicle to generate traveling information (S27) and transmits the generated traveling information to the service provider server 300 (S29).

Therefore, the analyzer 32 of the service provider server 300 analyzes fuel efficiency of the travel route and the driving pattern using the traveling information of the vehicle (S33) and stores and manages the analyzed data in the database 330 in order to use the analyzed data when retrieving a vehicle suiting a specific condition in step S17 (S35).

Here, when the driver retrieves the travel route after inputting a specific destination using the AVN system 30, the analyzer 320 may request optimal-fuel-efficiency driving pattern data for the specific destination from the service provider server 300, and the service provider server 300 generates the travel route to the destination in response thereto and, at the same time, generates the driving pattern data of the vehicle achieving optimal fuel efficiency.

At this time, the driving pattern may be analyzed by referring to the traveling information of the vehicle achieving the optimal fuel efficiency among vehicles traveling in similar sections.

Guidance on the driving pattern may be provided to the driver when the travel route is generated through interworking with a high-precision map.

In addition, the analyzer 320 may store driving patterns in the database 330 to be distinguished according to the road name. For example, the driving patterns may be stored in order of the road name, a start GPS value, an end GPS value, time information, weather information and real-time vehicle data.

In addition, the analyzer 320 may store optimal fuel efficiency in the database 330 to be distinguished according to the vehicle type, fuel type and displacement of the driver.

Meanwhile, the analyzer 320 may store the following three types (real-time vehicle traveling information, one-time vehicle traveling information and other traveling information in the database for analysis of the optimal fuel efficiency and driving pattern of each vehicle.

First, the real-time vehicle traveling information may include data such as a vehicle position, a degree of opening of an accelerator pedal, operation of a brake pedal, an instantaneous acceleration, a steering wheel angle or operation of a lamp/wiper and video data, the one-time vehicle traveling information may include a vehicle starting point, a destination, a departure time, an arrival time, an altitude, final fuel efficiency data, etc., and the other traveling information may include a local temperature, weather (rain or snow), a vehicle type, a fuel type, an engine displacement, etc.

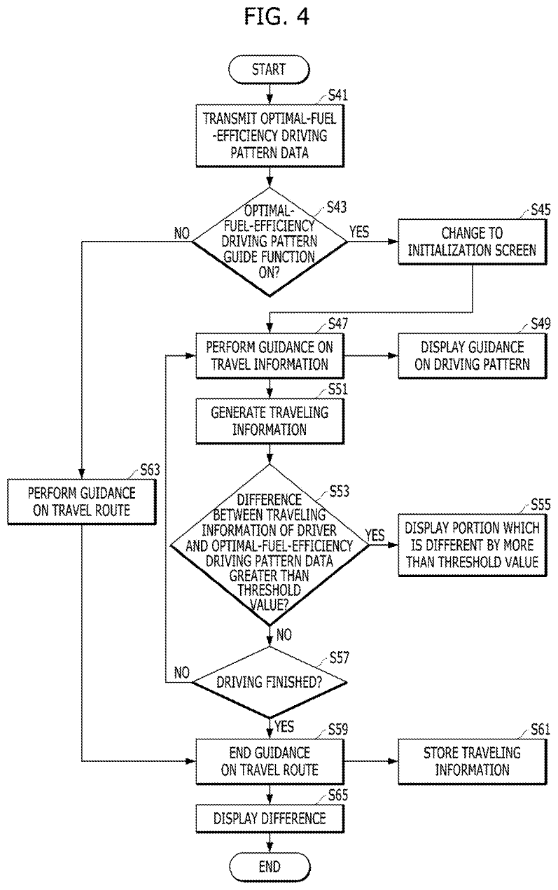

FIG. 4 is a flowchart illustrating a procedure of providing an optimal-fuel-efficiency driving pattern in another form of the present disclosure.

Referring to FIG. 4, as a specific pre-registered user requests an optimal-fuel-efficiency driving pattern guide service from the service provider server 300, the service provider server 300 transmits the optimal-fuel-efficiency driving pattern data to the first controller 20 of the vehicle infotainment system 100 when the optimal-fuel-efficiency driving pattern data is present (S41).

At this time, the first controller 20 determines whether a function for providing the optimal-fuel-efficiency driving pattern data received from the service provider server 300 is in an ON state (S43).

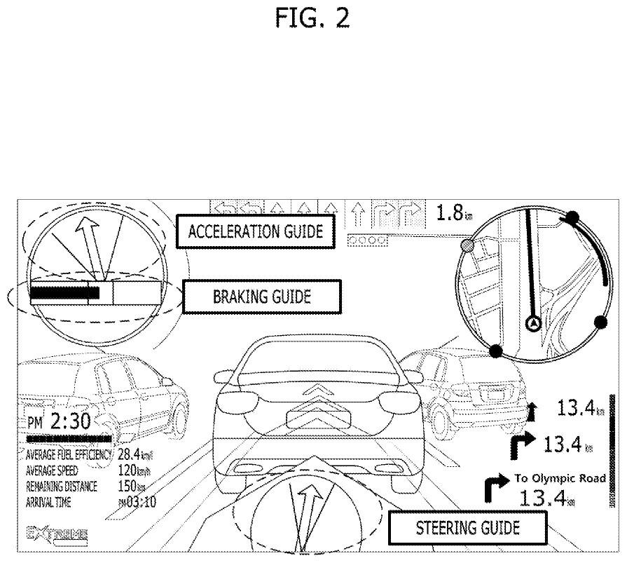

Upon determining that the function for providing the optimal-fuel-efficiency driving pattern data is in the ON state in step S43, the screen of the AVN system 30 or the AU-HUD is changed to an initialization screen to display an accelerator pedal, a brake pedal and steering as shown in FIG. 2 (S45), and the travel route is displayed on the screen of the AVN system 30 under control of the first controller 20 (S47).

Subsequently, the first controller 20 generates traveling information obtained by detecting the traveling state (e.g., operation state of an accelerator pedal, a brake and a steering wheel) of the driver of the vehicle through the sensor unit 10 including various sensors (S51).

Subsequently, the first controller 20 determines whether a difference between the traveling information generated at a predetermined period and the optimal-fuel-efficiency driving pattern data downloaded from the service provider server 300 is equal to or greater than a threshold value (S53).

At this time, upon determining that the difference between the traveling information and the optimal-fuel-efficiency driving pattern data is equal to or greater than the threshold value in step S53, the first controller 20 performs control to display a portion which is different by more than the threshold value through the AVN system 30 or the output unit 40 (S55).

In contrast, upon determining that the difference between the traveling information and the optimal-fuel-efficiency driving pattern data is less than the threshold value in step S53, whether driving on the current travel route is finished is determined (S57).

Upon determining that driving is finished in step S57, the first controller 20 finishes guidance on the current travel route (S59), transmits the traveling information to the service provider server 300 and stores the traveling information in the database 330 (S61).

Meanwhile, upon determining that the function for providing the optimal-fuel-efficiency driving pattern data is not in the ON state in step S43, guidance on the generally set traveling route to the destination is performed (S63) and the traveling guidance is finished.

Subsequently, the first controller 20 may display a difference between the fuel efficiency of the corresponding vehicle and the optimal-fuel-efficiency driving pattern through the AVN system 30.

In the above-described procedure of providing the optimal-fuel-efficiency driving pattern according to the travel route of the present disclosure, acceleration control operation displayed on the screen of the AVN system 30 or the AU-HUD displays the pedal effort of the accelerator pedal in the form of a maximum value/minimum value as shown in FIG. 2, displays a warning in the form of a color signal when the acceleration of the driver deviates from existing guide data, and guides the driver to approach optimal fuel efficiency.

In addition, the braking control operation displays the braking time and the pedal effort upon braking in a graphical form. Such braking control operation is usually dimmed and displayed. When braking operation is desired, the color of the braking control operation is changed and displayed to the driver and the pedal effort section upon braking operation is also displayed.

In addition, the steering control operation refers to operation of displaying the steering angle in the same direction as a ghost car in order to apply an optimal route to the vehicle. When the driver performs steering to deviate from the angle, the color of the steering control operation is changed and displayed to the driver to guide the driver to drive the vehicle in an optimal direction.

Meanwhile, after the driver finishes driving, the first controller 20 may compare the driving pattern of the driver with the driving pattern achieving optimal fuel efficiency and notify the driver of a portion having a difference through the AVN system 30. For example, a message “Acceleration and braking frequently occur”, “Pedal effort of the brake is high” or “Steering is suddenly changed” may be output.

In the system and method for providing the optimal-fuel-efficiency driving pattern according to the travel route of the present disclosure, when the driver sets a travel route to a specific destination, it is possible to provide the driver with optimal traveling information having optimal fuel efficiency matching the road conditions of the traveling route of the vehicle, the weather information and the vehicle information.

In addition, when the driver drives the vehicle in a state of setting a travel route to a specific destination, it is possible to provide the driver with guide information in real time such that the vehicle travels in an optimal travel pattern matching the road condition of the traveling route of the vehicle, the weather information and the vehicle information.

Therefore, it is possible to achieve optimal fuel efficiency according to the traffic conditions of the travel road set by the driver and the travel route and to continuously improve fuel efficiency through continuous driving pattern comparison and analysis.

The effects of the present disclosure are not limited to the above-described effects and other effects which are not described herein may be derived by those skilled in the art from the above description of the forms of the present disclosure.

The present disclosure can also be embodied as computer readable code on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, and optical data storage devices.

The above exemplary forms are therefore to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

What is claimed is:

1. A system for providing an optimal-fuel-efficiency driving pattern according to a travel route, the system comprising:
a vehicle infotainment system installed in a pre-registered vehicle and configured to:
detect and transmit traveling information of the pre-registered vehicle to an external server, and
guide a driver to drive the pre-registered vehicle using optimal-fuel-efficiency driving pattern data for a specific travel route downloaded from the external server;
a service provider server configured to:
collect traveling information of the pre-registered vehicle and customer data at a predetermined period,
analyze, store and manage a driving pattern of the pre-registered vehicle and fuel efficiency information with respect to the specific travel route,
transmit the optimal-fuel-efficiency driving pattern data to the vehicle infotainment system when a pre-registered user requests the optimal-fuel-efficiency driving pattern data for the specific travel route; and
a wireless communication network configured to enable data communication between the vehicle infotainment system and the service provider server.

2. The system according to claim 1, wherein the vehicle infotainment system includes:
at least one sensor configured to detect vehicle traveling information;
a first controller configured to control transmitting the vehicle traveling information detected by the at least one sensor to the service provider server, or configured to output the optimal-fuel-efficiency driving pattern data provided by the service provider server; and
an audio video navigation (AVN) system configured to:
enable wireless data communication with the service provider server,
transmit the vehicle traveling information received from the first controller to the service provider server, and
guide the driver to drive the vehicle using the optimal-fuel-efficiency driving pattern data for the specific travel route, which has been transmitted by the service provider server.

3. The system according to claim 1, wherein the service provider server includes:
a transceiver configured to transmit and receive data to and from one or more vehicle infotainment systems;
an analyzer configured to collect traveling information transmitted by each of the vehicle infotainment systems and to analyze fuel efficiency and driving pattern data;
a route extractor configured to extract a travel route to a destination based on a request of an optimal-fuel-efficiency driving pattern guide service;
a driving pattern extractor configured to:
extract the optimal-fuel-efficiency driving pattern data for the pre-registered vehicle from the driving pattern data stored for each travel route, or
store the extracted optimal-fuel-efficiency driving pattern data along with travel route information; and
a second controller configured to:
retrieve the optimal-fuel-efficiency driving pattern data matching the specific travel route, or a vehicle type and fuel type of the pre-registered vehicle, and
transmit the retrieved optimal-fuel-efficiency driving pattern data to the vehicle infotainment system.

4. A method of providing an optimal-fuel-efficiency driving pattern for a vehicle according to a travel route, the method comprising:
retrieving a travel route for the vehicle to a destination;
requesting, by a service provider server, an optimal-fuel-efficiency driving pattern guide service for the travel route;
extracting, by the service provider server, the travel route;
determining, by the service provider server, whether optimal-fuel-efficiency driving pattern data matching the travel route is present among prestored driving pattern data;
transmitting the travel route data and the optimal-fuel-efficiency driving pattern data from the service provider server to the vehicle when the optimal-fuel-efficiency driving pattern data matching the travel route is present; and
providing the travel route and the optimal-fuel-efficiency driving pattern data.

5. The method according to claim 4, wherein the vehicle performs driving control based on the optimal-fuel-efficiency driving pattern when an operation switch of the vehicle for performing guidance on the optimal-fuel-efficiency driving pattern is on.

6. The method according to claim 4, wherein the optimal-fuel-efficiency driving pattern includes at least one of steering guide information, acceleration guide information, or braking guide information, which is displayed on an augmented reality (AR)-navigation system or an augmented reality head-up display (AR-HUD).

7. The method according to claim 4, further comprising: storing, by the service provider server, traveling information of the vehicle when the vehicle completes traveling according to the travel route, wherein the traveling information includes a vehicle type, a fuel type of the vehicle, and displacement of a driver of the vehicle.

8. The method according to claim 7, wherein the service provider server is configured to collect and store real-time vehicle traveling information, one-time vehicle traveling information and other traveling information, for analysis of optimal fuel efficiency and a driving pattern of the vehicle.

9. A non-statutory computer-readable recording medium having recorded thereon a program for executing the method according to claim 4.
